(19) United States
(12) Patent Application Publication
(10) Pub. No.: US 2026/0105325 A1
(43) Pub. Date: Apr. 16, 2026

(54) DEVICE, A DATA STRUCTURE, AND A COMPUTER IMPLEMENTED METHOD FOR ANSWERING A FIRST ORDER LOGICAL QUERY BASED ON A KNOWLEDGE GRAPH

(71) Applicant: Robert Bosch GmbH, Stuttgart (DE)

(72) Inventors: Yunjie He, Stuttgart (DE); Bo Xiong, Stuttgart (DE); Evgeny Kharlamov, Muenchen (DE); Mojtaba Nayyeri, Stuttgart (DE); Steffen Staab, Stuttgart (DE); Yuqicheng Zhu, Stuttgart (DE)

(21) Appl. No.: 19/354,196

(22) Filed: Oct. 9, 2025

(30) Foreign Application Priority Data
Oct. 11, 2024 (DE) 10 2024 209 934.1

(51) Int. Cl. G06N 5/022; G06N 5/04

(52) U.S. Cl. CPC G06N 5/022; G06N 5/04

(57) ABSTRACT

A computer implemented method for answering a first order logical query based on a knowledge graph. The logical query defines a logical operation on a first triple and a second triple. The first triple includes a cone embedding representing a first set including at least one entity of the knowledge graph, a cone embedding representing a second set including at least one entity of the knowledge graph, and an embedding of a rotational operation between the two cone embeddings of the first triple in a complex embedding space. The second triple includes a cone embedding representing a third set including at least one entity of the knowledge graph, a cone embedding representing a fourth set including at least one entity of the knowledge graph, and an embedding of a rotational operation between the two cone embeddings of the second triple in the complex embedding space.

### CROSS REFERENCE

The present application claims the benefit under 35 U.S.C. § 119 of Germany Patent Application No. DE 10 2024 209 934.1 filed on Oct. 11, 2024, which is expressly incorporated herein by reference in its entirety.

### FIELD

The present invention relates to a device, a data structure, and a computer implemented method for answering a first order logical query based on a knowledge graph.

### BACKGROUND INFORMATION

Complex query answering over an incomplete knowledge graph requires reasoning over the available information in the knowledge graph to generate answers to a complex logical query. The task involves identifying the relevant entities and relations in the knowledge graph that are required to answer the query, and reasoning about the connections between them.

### SUMMARY

The present invention provides a device and computer implemented method for answering a first order logical query based on a knowledge graph which efficiently provides the answer.

According to an example embodiment of the present invention, the computer implemented method for answering the first order logical query based on the knowledge graph comprises providing the knowledge graph and the first-order logical query, wherein the logical query defines a logical operation on a first triple and a second triple, wherein the first triple comprises a cone embedding representing a first set comprising at least one entity of the knowledge graph, a cone embedding representing a second set comprising at least one entity of the knowledge graph, and an embedding of a rotational operation between the two cone embeddings of the first triple in a complex embedding space, wherein the second triple comprises a cone embedding representing a third set comprising at least one entity of the knowledge graph, a cone embedding representing a fourth set comprising at least one entity of the knowledge graph, and an embedding of a rotational operation between the two cone embeddings of the second triple in the complex embedding space, wherein one of the cone embeddings represents an answer to the logical query, determining an in particular directed acyclic computational graph for the logical query depending on the logical query, wherein the computational graph defines an order of executing the rotational operations, determining the answer to the logical query, wherein determining the answer comprises applying the rotational operations on the cone embeddings according to the order defined by the computational graph. This combines the advantages of cone embeddings as a well-specified geometric representation for query embedding and also the rotation operator as a powerful algebraic operation for pattern inference. The method defines each relation as a rotation from the source entity set to the answer/intermediate entity set and performs neural logical operators upon the selected entity sets in a complex vector space of the cone embeddings.

According to an example embodiment of the present invention, for training, the method may comprise providing the logical query together with a ground truth answer entity cone embedding, and training at least a part of the embeddings depending on a distance between the ground truth answer entity cone embedding and the cone embedding that represents the answer to the logical query in particular to minimize the distance.

According to an example embodiment of the present invention, for training, the method may comprise providing the logical query together with a negative sample, and training at least a part of the embeddings depending on a distance between the negative sample and the cone embedding that represents the answer to the logical query in particular to maximize the distance.

According to an example embodiment of the present invention, for testing, the method may comprise providing the logical query comprising an entity cone embedding of a given entity of the knowledge graph, providing a given ground truth cone embedding of a given answer entity associated with the given entity, determining the answer to the logical query comprising the entity cone embedding of the given entity, and testing the embeddings of the rotational operations depending on the distance between the answer determined for the logical query comprising the entity cone embedding of the given entity and the cone embedding of the given ground truth cone embedding of the given answer entity.

According to an example embodiment of the present invention, determining the answer may comprise determining, depending on the cone embedding that represents the answer to the logical query, the entity of the knowledge graph that is or the entities of the knowledge graph that are the answer to the logical query. This means, the entity of the entities of the knowledge graph that are valid answers according to the method, are provided.

The present invention also provides a device for answering a first order logical query based on a knowledge graph which comprises at least one processor and at least one memory, wherein the at least one memory is configured to store instructions that, when executed by the at least one processor cause the device to execute a method according to the present invention, wherein the at least one processor is configured to execute the instructions.

According to the present invention, a computer program for answering a first order logical query based on a knowledge graph may be provided, wherein the computer program comprises instructions that, when executed by the computer cause the computer to execute a method according to the present invention.

According to an example embodiment of the present invention, a data structure for answering a first order logical query based on a knowledge graph may be provided wherein the data structure comprises at least one data field for the knowledge graph or an embedding of the knowledge graph, that the data structure comprises at least one data field for the first-order logical query or an embedding of the first-order logical query, wherein the logical query defines a logical operation on a first triple and a second triple, wherein the first triple comprises a cone embedding representing a first set comprising at least one entity of the knowledge graph, a cone embedding representing a second set comprising at least one entity of the knowledge graph, and an embedding of a rotational operation between the two cone embeddings of the first triple in a complex embedding space, wherein the second triple comprises a cone embedding representing a third set comprising at least one entity of the knowledge graph, a cone embedding representing a fourth set comprising at least one entity of the knowledge graph, and an embedding of a rotational operation between the two cone embeddings of the second triple in the complex embedding space, wherein one of the cone embeddings represents an answer to the logical query, wherein the data structure comprises at least one data field for an in particular directed acyclic computational graph for the logical query depending on the logical query or an embedding of the computational graph, wherein the computational graph defines an order of executing the rotational operations, wherein the data structure comprises at least one data field for the answer to the logical query.

According to an example embodiment of the present invention, for training, the data structure may comprise at least one data field for a ground truth answer entity cone embedding, and a distance between the ground truth answer entity cone embedding and the cone embedding that represents the answer to the logical query.

According to an example embodiment of the present invention, for testing, the data structure may comprise at least one data field for a result of testing the embeddings of the rotational operations depending on the distance between the answer determined for the logical query comprising the entity cone embedding of the given entity and the cone embedding of the given ground truth cone embedding of the given answer entity.

Further example embodiments of the present invention are derived from the following description and the figures.

### BRIEF DESCRIPTION OF THE DRAWINGS

FIG. 1 schematically depicts a device for answering a first order logical query based on a knowledge graph, according to an example embodiment of the present invention.

FIG. 2A schematically depicts modelling of a symmetric relation, according to an example embodiment of the present invention.

FIG. 2B schematically depicts modelling of an inversion,

FIG. 2C schematically depicts modelling of a composition, according to an example embodiment of the present invention.

FIG. 3 depicts a flow chart with steps of a method device for answering the first order logical query based on the knowledge graph, according to an example embodiment of the present invention.

FIG. 4 schematically depicts a data structure for answering the first order logical query based on the knowledge graph, according to an example embodiment of the present invention.

### DETAILED DESCRIPTION OF EXAMPLE EMBODIMENTS

FIG. 1 schematically depicts a device 100 for answering a first order logical query based on a knowledge graph.

The device 100 comprises at least one processor 102 and at least one memory 104.

The at least one processor 102 is configured for executing instructions that, when executed by the at least one processor 102 cause the device 100 to execute a method for answering the first order logical query based on the knowledge graph.

The at least one memory 104 is configured to store the instructions. The at least one memory 104 is configured to store the knowledge graph.

The knowledge graph comprises entities and relations. An exemplary knowledge graph G comprises a set V of entities (vertices) and a set E of relations (edges).

The exemplary knowledge graph is defined as a set of factual triple

$$G = \{ ( {s}_{i} , {p}_{j} , {o}_{k} ) \} ⊂ V \times E \times V$$

wherein pⱼ∈E represents a predicate, sⱼ∈V represents a subject, and oₖ∈V represents an object.

An exemplary first order logical query q[V?] comprises a variable V? representing an answer entity from the knowledge graph G and a variable V representing an entity from the knowledge graph G or variables Vᵢ representing one entity from the knowledge graph G respectively. The exemplary first-order logical query q[V?] comprises an entity constant representing an entity from the knowledge graph G or entity constants representing one entity from the knowledge graph G respectively. The exemplary first-order logical query q[V?] comprises a relation constant that represents a relation from the knowledge graph G or relation constants that represent one relation from the knowledge graph G respectively.

The first-order logical query q[V?] comprises triples.

A respective triple of the first-order logical query q[V?] may comprise one constant that represents a relation from the knowledge graph G, and a first variable that represents an entity from the knowledge graph G, and a second variable that represents an entity from the knowledge graph G. A respective triple of the first-order logical query q[V?] may comprise a first constant that represents a relation from the knowledge graph G, a second constant that represents an entity from the knowledge graph G, and on variable that represents an entity from the knowledge graph G.

The first-order logical query q[V?] comprises logical operations on the triples. The first-order logical query q[V?] for example comprises existential quantification ∃, conjunction ∧, disjunction V, and negation ¬ to define logical operations on the triples. Universal quantification ∀ may not be included, as no entity connects with all other entities in real-world knowledge graph.

An example for representing the first-order logical query q[V?] is the Disjunctive Normal Form (DNF) described for example in Davey, B. A. and Priestley, H. A., “Introduction to lattices and order;” Cambridge university press, 2002.

The DNF represents the first-order logical query q[V?] as a disjunction of conjunctions. Vₐ⊂V is a non-variable anchor entity set representing the at least two entity constants, V₁, . . . , Vₖ are existentially quantified bound variables representing a respective entity of the knowledge graph G, and V? is the target variable, i.e., represents the answer entity to the first-order logical query q[V?].

A first-order logical query q in the disjunctive normal form is:

$$q [ V ? ] = V ? . ∃ {V}_{1} , … , {V}_{k} : {c}_{1} ∨ {c}_{2} ∨ … ∨ {c}_{n} .$$

wherein cᵢ are conjunctions, i.e., cᵢ=eᵢ₁ ∧ . . . ∧ eᵢₘ, where eᵢⱼ=r(vₐ, V) or ¬r(va, V) or r(V′, V) or ¬r(V′, V), vₐ∈Vₐ, V∈{V?, V₁, . . . , Vₖ}, V′ ∈{V₁, . . . , Vₖ}, and V≠V′.

The relational function rⱼ (·,·)∈R is a binary function rⱼ: V×V=→{True, False} corresponding to the predicate pⱼ of a triple (sᵢ, pⱼ, oₖ)∈G from the knowledge graph G, where rⱼ(sᵢ,oₖ)=True if and only if (sᵢ, pⱼ, oₖ) is a factual triple. This means, for all (sᵢ, pⱼ, oₖ)∈G, rⱼ(sᵢ, oₖ)=True.

Answering the first-order logical query q[V?] comprises finding a set of entities [symbol] q [symbol] ⊂V, where v∈ [symbol] q [symbol] if and only if q[v] is True.

A computation graph may be used for finding the set of entities [symbol] q [symbol] . For a given first-order logical query q[V?], the computation graph comprises nodes representing entity sets and edges represent logical operations over entity sets.

The logical operators are mapped to the edges of the computational graph according to the following rules:

Given a set of entities S c V and the relational function r∈R, a projection operator P outputs the adjacent entities ∪_{v∈S} N (v,r), where N (v,r) is the set of entities such that r(v, v′)=True for all v′ ∈N (v,r).

The conjunction operator is mapped to an intersection operator I. Given n sets of entities {S₁,S₂, . . . , Sₙ}, the intersection operator I perform set intersection to obtain

$${⋂}_{i = 1}^{n} {S}_{n} .$$

The disjunction operator is mapped to an union operator U. Given n sets of entities {S₁,S₂, . . . , Sₙ}, the union operator U performs set union to obtain

$${⋃}_{i = 1}^{n} {S}_{n} .$$

The negation operator is mapped to a complement operator C. Given an entity set S⊂V, C gives S̅=V\S.

Answering the first-order logical query q[V?] comprises determining a cone embedding that models an embedding region of the set of entities [symbol] q [symbol] .

The set of entities [symbol] q [symbol] is embedded to a Cartesian product of sector-cones. The set of entities [symbol] q [symbol] is for example embedded to the Cartesian product of sector-cones as described in Zhanqiu Zhang, Jie Wang, Jiajun Chen, Shuiwang Ji, and Feng Wu; 2021; “Cone: Cone embeddings for multi-hop reasoning over knowledge graphs;” in Advances in Neural Information Processing Systems 34: Annual Conference on Neural Information Processing Systems 2021, NeurIPS 2021 Dec. 6-14, 2021, virtual, pages 19172-19183.

The cone embedding of the set of entities [symbol] q [symbol] is for example:

$${V}_{q}^{c} = ( {θ}_{ax} , {θ}_{a p} )$$

where θₐₓ ∈[−π, π)^{d} are axes and θₐₚ ∈[0, 2π]^{d} are apertures. The cone embedding of a single entity v∈V is for example defined as v=(θₐₓ, 0), wherein 0 is a d-dimensional vector with all elements being Zero.

Relations in the knowledge graph G may form particular patterns. Relations may be symmetric or anti-symmetric. Some relations may be inverse of other relations.

Answering the first-order logical query q[V?] comprises modelling the first-order logical query q[V?] as a rotational operation on a cone embedding or as successive rotational operations on cone embeddings in complex space. An example for the rotational operation is described in Zhiqing Sun, Zhi-Hong Deng, Jian-Yun Nie, and Jian Tang; 2019; “Rotate: Knowledge graph embedding by relational rotation in complex space;” CoRR, abs/1902.10197.

An exemplary first cone 200 is defined between an upper bound

$${h}_{U}^{j}$$

ana a lower bound

$${h}_{L}^{j} .$$

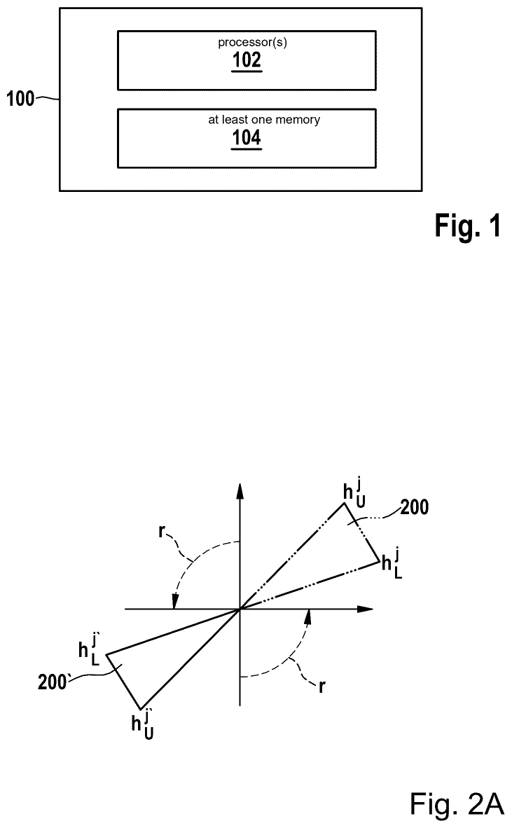

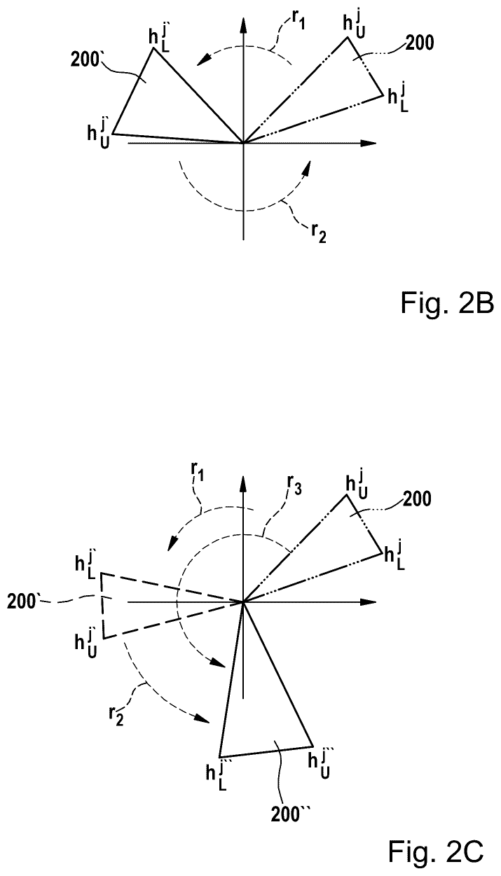

FIG. 2A depicts modelling of a symmetric relation between the first cone 200 and a second cone 200′ that is defined between upper bound

$${h}_{U}^{j ′}$$

and a lower bound

$${h}_{L}^{j ′}$$

and has the symmetric relation with the first cone 200. The symmetric relation is modelled by a counter-clock-wise rotation r from the first cone 200 to the second cone 200′. The symmetric relation is modelled by the counter-clock-wise rotation r from the second cone 200′ to the first cone 200.

FIG. 2B depicts modelling of an inversion between the first cone 200 and the second cone 200′. The inversion is modelled by a first counter-clock-wise rotation r₁ from the first cone 200 to the second cone 200′. The inversion is modelled by a second counter-clock-wise rotation r₂ from the second cone 200′ to the first cone 200.

FIG. 2C depicts modelling of a composition of the first cone 200 and the second cone 200′ to a third cone 200″. The composition is modelled by a first counter-clock-wise rotation r₁ from the first cone 200 to the second cone 200′. The composition is modelled by a second counter-clock-wise rotation r₂ from the second cone 200′ to the third cone 200″. The composition is modelled by a third counter-clock-wise rotation r₃ from the first cone 200 to the third cone 200″.

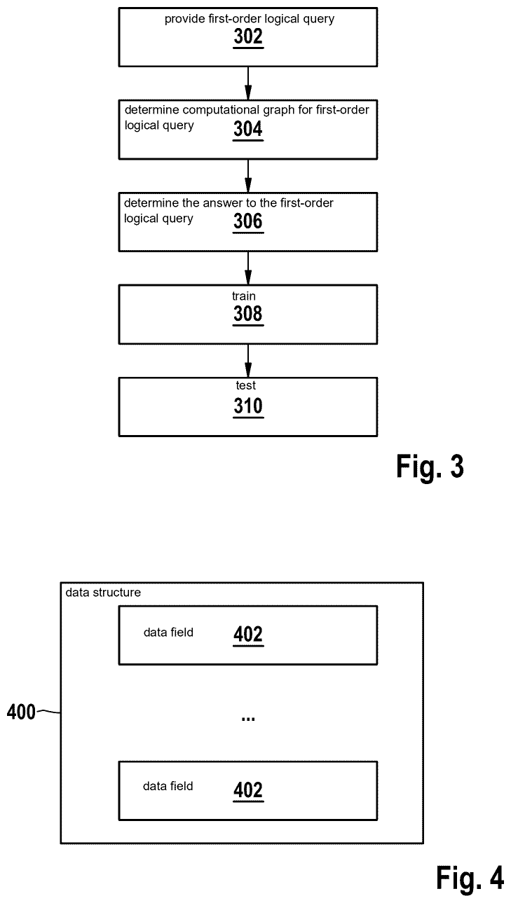

FIG. 3 depicts a flow-chart comprising steps of the method.

The method comprises a step 302.

The step 302 comprises providing the first-order logical query q[V?] and the knowledge graph G.

The method is described by way of example of a first-order logical query q[V?] that comprises a logical operation, e.g., a conjunction, of a first triple (h₁, r₁, t₁) and a second triple (h₂, r₂, t₂), wherein h₁, h₂ represent a respective cone embedding in a head of the respective triple, r₁, r₂ represent a respective rotational operation in the respective triple, and t₁, t₂ represent a respective rotated cone embedding in a tail of the respective triple.

The head of the first triple (h₁, r₁, t₁) comprises the cone embedding of one constant entity of the knowledge graph G.

The tail of the first triple (h₁, r₁, t₁) comprises the cone embedding of the variable V representing the entity of the knowledge graph G.

The head of the second triple (h₂, r₂, t₂) comprises the cone embedding of the variable V? representing the answer entity of the knowledge graph G.

The tail of the second triple (h₂, r₂, t₂) comprises the cone embedding of the variable V representing the entity of the knowledge graph G.

The first-order logical query q[V?] defines a condition for the variable V? that represents the answer entity from the knowledge graph G. According to the example, an entity from the knowledge graph G is a valid answer entity if the condition is met.

The relations of the respective triples in the first-order logical query q[V?] define a respective rotational operation on the cone embeddings representing the respective heads of the respective triple.

The relations of the respective triples comprise for example a respective rotational operation embedding.

The method comprises a step 304.

The step 304 comprises determining the computational graph for the first-order logical query q[V?] depending on the logical operation.

The computational graph for the first-order logical query q[V?] defines an order of executing the rotational operations.

According to the exemplary first-order logical query q[V?] that comprises the conjunction of the first triple (h₁, r₁, t₁) and the second triple (h₂, r₂, t₂), the computational graph defines that the cone embedding h₁ is rotated with the rotational operation r₁ to determine the cone embedding ty and the cone embedding h₂ is rotated with the rotational operation r₂ to determine the cone embedding t₂.

According to the example, the computational graph is a directed acyclic graph tree. The logical operations are performed in the order defined by the directed acyclic graph tree.

This is explained by way of example of the conjunction of the first triple (h₁, r₁, t₁) and the second triple (h₂, r₂, t₂), wherein the head h of the first triple is a constant representing an entity of the knowledge graph G, the tail t₁ of the first triple is a variable V representing an entity of the knowledge graph G, the head h₂ of the second triple is the variable V? that represents the answer entity from the knowledge graph G, and the tail t₂ of the second triple is the variable V representing the entity of the knowledge graph G.

The computational graph is the acyclic graph tree that comprises the head h₁ of the first triple as anchor node, an intermediate node representing the variable V and an answer node representing the variable V?.

The computational graph comprises a tree relation between the anchor node and the intermediate node defining the rotation according to the relation r₁ or the rotations according to the relation r₁ in the first triple. The computational graph comprises a tree relation between the intermediate node and the answer node defining the rotation according to the relation r₂ in the second triple. The respective tree relation defines for example the counter-clock-wise rotation for the symmetry, or the inversion, or the counter-clock-wise rotations for the composition.

The result of the rotation according to the relation r₁ in the first triple is a cone embedding representing a first set of entities from the knowledge graph G. The result of the rotation according to the relation r₂ in the second triple is a cone embedding representing a second set of entities from the knowledge graph G. The conjunction defines that the rotation according to the relation r₂ in the second triple is performed on the cone embedding representing the first set of entities.

The method comprises a step 306.

The step 306 comprises determining the answer to the first-order logical query q[V?] by applying the rotational operations on the cone embeddings according to the order defined by the computational graph.

To determine the answer to the first-order logical query q[V?], for example the cone embedding for the head h₂ of the second triple representing the answer entity, i.e., representing V?, is found.

The method comprises a step 308.

The step 308 comprises training.

For training, the first-order logical query q[V?] is provided together with a ground truth answer entity cone embedding. The ground truth answer entity cone embedding may be a cone with aperture Zero, i.e., upper bound and a lower bound of the cone embedding representing the answer entity are identical.

In the training, the distance between the upper bound and a lower bound of the cone embedding that is found and the ground truth answer entity cone embedding is minimized.

The distance is for example minimized by learning embeddings of the anchor node entities or embeddings of the rotational operations, i.e., the parameters that define the rotational operations.

For example, the logical query is provided together with the ground truth answer entity cone embedding. Then, at least a part of the embeddings is learned depending on a distance between the ground truth answer entity cone embedding and the cone embedding that represents the answer to the logical query. The training comprises for example learning the embeddings that minimize the distance.

The training may comprise providing negative samples and maximizing the distance between the embedding that represents the answer and negative samples.

The method comprises a step 310.

The step 310 comprises testing.

For testing, the logical operators parameterized with the parameters from the training are executed along the computation graph, starting from the learned embeddings of the anchor node entities.

The training comprises for example learning to answer the first-order logical query q[V?] input comprising the knowledge graph G and the first-order logical query q[V?]. A multi-layer perceptron network may be trained for selecting an answer entity from the knowledge graph G depending on the input.

The multi-layer perceptron network is for example learned from a low-dimensional vector representation of the input.

The answer entity to the first-order logical query is for example determined by the multi-layer perceptron network that is trained for selecting an answer entity from the knowledge graph G depending on the input.

FIG. 4 schematically depicts a data structure 400 for answering the first order logical query based on the knowledge graph.

The data structure 400 comprises at least one data field 402 for
the knowledge graph,
the first-order logical query,
the in particular directed acyclic computational graph, and
the answer to the logical query, and/or an embedding thereof.

The data structure 400 may comprise at least one data field 402 for a ground truth answer entity cone embedding, and a distance between the ground truth answer entity cone embedding and the cone embedding that represents the answer to the logical query.

The data structure 400 may comprise at least one data field 402 for a result of testing the embeddings of the rotational operations depending on the distance between the answer determined for the logical query comprising the entity cone embedding of the given entity and the cone embedding of the given ground truth cone embedding of the given answer entity.

The result may be pass or failed, or a digital indication thereof.

What is claimed is:

1. A computer implemented method for answering a first order logical query based on a knowledge graph, the method comprising the following steps:
providing the knowledge graph and the first-order logical query, wherein the logical query defines a logical operation on a first triple and a second triple, wherein the first triple includes a cone embedding representing a first set including at least one entity of the knowledge graph, a cone embedding representing a second set comprising at least one entity of the knowledge graph, and an embedding of a rotational operation between the cone embeddings of the first triple in a complex embedding space, wherein the second triple includes a cone embedding representing a third set including at least one entity of the knowledge graph, a cone embedding representing a fourth set including at least one entity of the knowledge graph, and an embedding of a rotational operation between the cone embeddings of the second triple in the complex embedding space, wherein one of the cone embeddings of the first and second triples represents an answer to the logical query;
determining a directed acyclic computational graph for the logical query depending on the logical query, wherein the computational graph defines an order of executing the rotational operations of the first and second triples; and
determining the answer to the logical query, wherein the determining of the answer includes applying the rotational operations on the cone embeddings of the first and second triples according to the order defined by the computational graph.

2. The method according to claim 1, further comprising:
providing the logical query together with a ground truth answer entity cone embedding; and
training at least a part of the embeddings of the first and second triples depending on a distance between the ground truth answer entity cone embedding and the cone embedding that represents the answer to the logical query to minimize the distance.

3. The method according to claim 1, further comprising:
providing the logical query together with a negative sample; and
training at least a part of the embeddings for the first and second triples depending on a distance between the negative sample and the cone embedding that represents the answer to the logical query to maximize the distance.

4. The method according to claim 2, wherein the providing of the logical query includes providing an entity cone embedding of a given entity of the knowledge graph, providing a given ground truth cone embedding of a given answer entity associated with the given entity, determining the answer to the logical query including the entity cone embedding of the given entity, and testing the embeddings of the rotational operations of the first and second triples depending on the distance between the answer determined for the logical query including the entity cone embedding of the given entity and the cone embedding of the given ground truth cone embedding of the given answer entity.

5. The method according to claim 1, wherein the determining of the answer includes determining, depending on the cone embedding that represents the answer to the logical query, the entity of the knowledge graph that is or the entities of the knowledge graph that are the answer to the logical query.

6. A device for answering a first order logical query based on a knowledge graph, the device comprising:
at least one processor; and
at least one memory, wherein the at least one memory is configured to store instructions that, when executed by the at least one processor cause the device to execute a method including the following steps:
providing the knowledge graph and the first-order logical query, wherein the logical query defines a logical operation on a first triple and a second triple, wherein the first triple includes a cone embedding representing a first set including at least one entity of the knowledge graph, a cone embedding representing a second set comprising at least one entity of the knowledge graph, and an embedding of a rotational operation between the cone embeddings of the first triple in a complex embedding space, wherein the second triple includes a cone embedding representing a third set including at least one entity of the knowledge graph, a cone embedding representing a fourth set including at least one entity of the knowledge graph, and an embedding of a rotational operation between the cone embeddings of the second triple in the complex embedding space, wherein one of the cone embeddings of the first and second triples represents an answer to the logical query,
determining a directed acyclic computational graph for the logical query depending on the logical query, wherein the computational graph defines an order of executing the rotational operations of the first and second triples, and
determining the answer to the logical query, wherein the determining of the answer includes applying the rotational operations on the cone embeddings of the first and second triples according to the order defined by the computational graph;
wherein the at least one processor is configured to execute the instructions.

7. A non-transitory computer-readable medium on which is stored a computer program for answering a first order logical query based on a knowledge graph, the program, when executed by a computer, causing the computer to perform the following steps comprising:
providing the knowledge graph and the first-order logical query, wherein the logical query defines a logical operation on a first triple and a second triple, wherein the first triple includes a cone embedding representing a first set including at least one entity of the knowledge graph, a cone embedding representing a second set comprising at least one entity of the knowledge graph, and an embedding of a rotational operation between the cone embeddings of the first triple in a complex embedding space, wherein the second triple includes a cone embedding representing a third set including at least one entity of the knowledge graph, a cone embedding representing a fourth set including at least one entity of the knowledge graph, and an embedding of a rotational operation between the cone embeddings of the second triple in the complex embedding space, wherein one of the cone embeddings of the first and second triples represents an answer to the logical query;
determining a directed acyclic computational graph for the logical query depending on the logical query, wherein the computational graph defines an order of executing the rotational operations of the first and second triples; and
determining the answer to the logical query, wherein the determining of the answer includes applying the rotational operations on the cone embeddings of the first and second triples according to the order defined by the computational graph.

8. A data structure for answering a first order logical query based on a knowledge graph, the data structure comprising:
at least one data field for the knowledge graph or an embedding of the knowledge graph;
at least one data field for the first-order logical query or an embedding of the first-order logical query, wherein the logical query defines a logical operation on a first triple and a second triple, wherein the first triple includes a cone embedding representing a first set comprising at least one entity of the knowledge graph, a cone embedding representing a second set comprising at least one entity of the knowledge graph, and an embedding of a rotational operation between the cone embeddings of the first triple in a complex embedding space, wherein the second triple includes a cone embedding representing a third set comprising at least one entity of the knowledge graph, a cone embedding representing a fourth set including at least one entity of the knowledge graph, and an embedding of a rotational operation between the cone embeddings of the second triple in the complex embedding space, wherein one of the cone embeddings of the first and second triples represents an answer to the logical query;
at least one data field for a directed acyclic computational graph for the logical query depending on the logical query or an embedding of the computational graph, wherein the computational graph defines an order of executing the rotational operations;
at least one data field for the answer to the logical query.

9. The data structure according to claim 8, further comprising:
at least one data field for a ground truth answer entity cone embedding, and a distance between a ground truth answer entity cone embedding and the cone embedding that represents the answer to the logical query.

10. The data structure according to claim 9, further comprising:
at least one data field for a result of testing the embeddings of the rotational operations of the first and second triples depending on the distance between the answer determined for the logical query including a entity cone embedding of a given entity and a cone embedding of a given ground truth cone embedding of a given answer entity.
